(19) United States
(12) Patent Application Publication
(10) Pub. No.: US 2026/0164397 A1
(43) Pub. Date: Jun. 11, 2026

(54) METHOD OF MODEL TRAINING & INFERENCE PHASES FOR AI/ML-BASED POSITIONING

(71) Applicants: Centre of Excellence in Wireless Technology, Chennai, Tamil Nadu (IN); Indian Institute of Technology Madras (IIT Madras), Chennai, Tamil Nadu (IN)

(72) Inventors: Jishnu Ponnappan, Chennai (IN); Abhijeet Abhimanyu Masal, Chennai (IN); Shiv Shankar, Chennai (IN); Anusuya Balasubramanian, Chennai (IN); Vikram Krishnakumar, Chennai (IN); Aswathy Subramaniam, Chennai (IN); Harini Shree Velmurugan, Chennai (IN); K. B. S. M. D. S. Sai Prasanth, Chennai (IN); Anil Kumar Yerrapragada, Chennai (IN); Jeniston Deviraj Klutto Milleth, Chennai (IN); Bhaskar Ramamurthi, Chennai (IN)

(21) Appl. No.: 19/383,159

(22) Filed: Nov. 7, 2025

(30) Foreign Application Priority Data
Nov. 8, 2024 (IN) 202441086264

(51) Int. Cl. H04W 64/00

(52) U.S. Cl. CPC H04W 64/00

(57) ABSTRACT

A method of positioning in a wireless communication network is described. The method comprises receiving, by a user equipment (UE), an LTE positioning protocol (LPP) signaling from a location management function (LMF). The UE transmits at least one capability message indicating support for at least one AI/ML model for at least one first positioning estimation functionality. The UE receives at least one configuration from the LMF. The UE performs AI/ML inference of at least one of UE location estimate and measured features using the at least one AI/ML model based on at least one second positioning estimation functionality and reference signal configurations. The UE transmits at least one of UE location estimate and measured features, to the LMF.

### CROSS-REFERENCE TO RELATED APPLICATION

This application claims the benefit of priority of Indian Patent Application number 202441086264 filed Nov. 8, 2024, the contents of which is incorporated by reference in its entirety.

### FIELD OF THE INVENTION

The present invention relates to positioning in cellular/mobile network, and more particularly to position estimation in cellular networks using AI/ML.

### BACKGROUND OF THE INVENTION

Positioning is one of the very strong and vital features in the 5G/6G mobile communication technology, due to its wide range of business applications. Emergency call positioning is emerging as an important use case due to regulatory requirements from the Federal Communications Commission (FCC). Many other critical services rely on positioning as well, with much more stringent requirements on accuracy, time to first fix, and latency. Further various commercial applications and use cases are coming up with more stringent positioning requirements in 5G and beyond systems.

Studies are going on to explore the benefits of augmenting the air-interface with features enabling improved support for AI/ML. The 3^{rd} generation partnership project (3GPP) framework for Artificial Intelligence/Machine Learning (AI/ML) is studied for air-interface corresponding to each target use case regarding aspects such as performance, complexity, and potential specification impact. The functional framework for AI/ML for NR air interface illustrated in FIG. 1.

There is a need of devising methods for training AI/ML models for estimating position of User Equipment in wireless communication network.

### OBJECTS OF THE INVENTION

A general objective of the present invention is to provide a method of positioning devices in a wireless communication network.

Another objective of the present invention is to determine location of User Equipment (UEs) using an artificial intelligence/machine learning (AI/ML) techniques/models.

Yet another objective of the present invention is to train AI/ML models in a wireless positioning system.

Still another objective of the present invention is to train AI/ML models for positioning estimation on a User Equipment (UE) or associated over-the-top (OTT) server.

### SUMMARY OF THE INVENTION

The summary is provided to introduce a method of positioning in a wireless communication network, and the method is further described below in the detailed description. This summary is not intended to identify essential features of the claimed subject matter nor is it intended for use in determining or limiting the scope of the claimed subject matter.

In one embodiment, a method of positioning in a wireless communication network comprises receiving, by a user equipment (UE), an LTE positioning protocol (LPP) signaling from a location management function (LMF). The method further comprises transmitting, by the UE, at least one capability message. The at least one capability message indicates support for at least one AI/ML model for at least one first positioning estimation functionality. The method further comprises receiving, by the UE, at least one configuration from the LMF. The method further comprises performing, by the UE, AI/ML inference of at least one of UE location estimate and measured features using the at least one AI/ML model based on at least one second positioning estimation functionality and reference signal configurations. The method further comprises transmitting, by the UE, at least one of UE location estimate and measured features, to the LMF.

In one aspect, the first positioning estimation functionality comprises at least one of time difference of arrival (TDoA), angle of arrival (AoA), angle of departure (AoD), time of arrival (ToA), and received signal power metrics.

In one aspect, the LPP signaling from the LMF comprises at least one capability signaling and assistance data signaling.

In one aspect, the at least one configuration comprises indicating at least one third positioning estimation functionality from the at least one first positioning estimation functionality based on network-side conditions.

In one aspect, the at least one second positioning estimation functionality is selected from the at least one third positioning estimation functionality in accordance with at least one of network-side and UE-side conditions, and reporting the at least one second positioning estimation functionality to the LMF.

In one aspect, the at least one AI/ML model comprises at least one attribute, and wherein the at least one attribute comprises at least one of model accuracy, retraining capability, and availability time duration.

In one aspect, the UE receives the AI/ML model from at least one of the LMF and an over-the-top (OTT) server.

In one aspect, the UE performs inference in one of a proactive manner by autonomous reporting and a reactive manner in response to an LMF query.

In one embodiment, a method for determining a location of a UE using an artificial intelligence/machine learning (AI/ML) model comprises receiving, by a location management function (LMF), a location service (LCS) request from an access and mobility management function (AMF). The method further comprises establishing, by the LMF, a communication link with at least one of the UE, a serving transmission/reception point (TRP) and at least one neighboring TRP. The method further comprises determining, by the LMF, a suitable positioning method and an LMF-side AI/ML model. The method further comprises obtaining, by the LMF, at least one positioning measurement data from at least one of the UE, the serving TRP and neighboring TRPs. The method further comprises performing, by the LMF, an AI/ML model inference using the at least one positioning measurement data to estimate the UE location. The method further comprises providing, by the LMF, the UE location estimate to an LCS consumer.

In one aspect, the suitable positioning method is one of TDoA, RToA, AoA, AoD, multi-round trip time (m-RTT), and carrier phase-based.

In one aspect, the UE location estimate further comprises positioning measurement data derived from the UE location.

In one aspect, the communication link is one of link established between the LMF and the UE, and the link established between the LMF and one of the serving TPR and the neighboring TRP.

In one aspect, the link established between the LMF and the UE uses LTE positioning protocol (LPP), and the link established between the LMF and one of the serving TPR and the neighboring TRP uses one of NR positioning protocol (NRPPa) and LPPa.

In one aspect, the positioning measurement derived from the UE location comprises at least one of LOS condition, ToA, carrier phase of arrival, AoA, and AoD.

In one aspect, the AI/ML model is received from at least one of a model repository and a model training logical function (MTLF).

In one aspect, the at least one positioning measurement data comprises at least one of time difference of arrival (TDoA), relative time of arrival (RToA), angle of arrival (AoA), angle of departure (AoD), time of arrival (ToA), gNB/UE Tx-RX time difference of arrival, synchronization information, path phase, RSRP, measurement windows, path powers, and line-of-sight (LoS) condition.

In one embodiment, a method for performing positioning inference using an AI/ML model comprises receiving by a base station (BS), a request from a location management function (LMF) to initiate an AI/ML-based positioning procedure. The method further comprises configuring, by the BS, to obtain at least one channel measurement data for a user equipment (UE). The method further comprises receiving, by the BS, the at least one channel measurement data from the UE. The method further comprises performing, by the BS, an inference using a gNB-side AI/ML model and the at least one channel measurement data to estimate at least one of, the estimate of UE location parameter and at least one positioning measurement parameter. The method further comprises transmitting, by the BS, at least one of the UE location parameters and at least one positioning measurement parameter to the LMF.

In one aspect, the gNB receives the AI/ML model from at least one of the LMF and an operations and management (OAM) server.

In one aspect, the at least one channel measurement data comprises at least one of path power, channel impulse response, path delays, path phase and path angles (AoD/AoA).

In one aspect, the at least one positioning measurement parameter include at least one of multipath delays, time difference of arrival (TDoA), relative time of arrival (RToA), angle of arrival (AoA), angle of departure (AoD), time of arrival (ToA), gNB/UE Tx-RX time difference of arrival, synchronization information, path phase, RSRP, measurement windows, path powers, and line-of-sight (LoS) condition.

In one embodiment, a method for training an AI/ML model in a wireless positioning system comprises receiving, by a location management function (LMF), a data collection request from at least one entity among a user equipment (UE), base station (BS), or a network function (NF). The method further comprises subscribing, by the LMF, to an access and management function (AMF) to obtain at least one participating entity within an area of interest. The method further comprises receiving, by the LMF, the at least one participating entity. The method further comprises configuring, by the LMF, at least one positioning measurement reporting from at least one participating entity using at least one of LPP and NRPPa signalling. The method further comprises obtaining, by the LMF, at least one of, at least one positioning measurement data and corresponding ground truth label (GTL) data from the at least one of UE and gNB. The method further comprises forwarding, by the LMF, at least one of, at least one positioning measurement data and corresponding ground truth label (GTL) data to a designated training entity for AI/ML model training.

In one aspect, the at least one participating entity comprises positioning capabilities.

In one aspect, the BS is one of gNB, eNB, ng-eNB, and 6 gNB.

In one aspect, the at least one participating entity is at least one user equipment (UE), or customer premise equipment (CPE).

In one aspect, the at least one participating entity is identified using at least one of user equipment identifiers, subscription permanent identifier (SUPI), subscriber concealed identifier (SUCI), 5G globally unique temporary identity (5G-GUTI), permanent equipment identifier (PEI), and generic public subscription identifier (GPSI).

In one aspect, the designated training entity is one of the BS, the UE, network data analytics function (NWDAF), model training and learning function (MTLF), operation and management (OAM) entity or external data collection server.

In one aspect, the at least one positioning measurement data is at least one of path power, channel impulse response, path phase multipath delays, time difference of arrival (TDoA), relative time of arrival (RToA), angle of arrival (AoA), angle of departure (AoD), time of arrival (ToA), gNB/UE Tx-RX time difference of arrival, synchronization information, path phase, RSRP, measurement windows, path powers, and line-of-sight (LoS) condition.

In one aspect, the at least one GTL data is at least one of time difference of arrival (TDoA), relative time of arrival (RToA), angle of arrival (AoA), angle of departure (AoD), time of arrival (ToA), gNB/UE Tx-RX time difference of arrival, line-of-sight (LoS) condition and the at least one participating entity location.

In one aspect, the designated training entity trains at least one positioning AI/ML model based on the at least one positioning measurement data and at least one ground truth label received from the LMF and provides indication to initiate new data collection when model performance degradation is detected.

In one aspect, the training is performed by at least one BS utilizing at least one of, at least one positioning measurement data and at least one GTL data received from the LMF via an NRPPa Measurement Trigger Response message.

In one aspect, the training is performed by an LMF-integrated model training logical function (MTLF) triggered upon receiving an LCS request.

In one embodiment, a method implemented at a User Equipment (UE) or associated over-the-top (OTT) server for training an AI/ML model for positioning estimation comprises receiving, by at least one UE, a data collection request from a training entity in OTT server. The method further comprises collecting, by at least one UE, at least one of at least one channel measurement data and at least one positioning measurement data. The method further comprises associating, by at least one UE, the positioning measurements with at least one ground truth label. The method further comprises transmitting, by at least one UE, the at least one positioning measurement data and at least one ground truth label to the OTT server.

In one aspect, the method further comprises training, by the OTT server, at least one AI/ML model for UE positioning, using the at least one positioning measurement data and at least one ground truth label. The method further comprises periodically monitoring by the OTT server, model performance and initiating retraining as required.

In one aspect, the at least one channel measurement data comprises at least one of path power, channel impulse response, path delays, path phase and path angles (AoD/AoA).

In one aspect, the at least one positioning measurement data is at least one of path power, channel impulse response, path phase multipath delays, time difference of arrival (TDoA), relative time of arrival (RToA), angle of arrival (AoA), angle of departure (AoD), time of arrival (ToA), gNB/UE Tx-RX time difference of arrival, synchronization information, path phase, RSRP, measurement windows, path powers, and line-of-sight (LoS) condition.

In one aspect, the at least one GTL data is at least one of time difference of arrival (TDoA), relative time of arrival (RToA), angle of arrival (AoA), angle of departure (AoD), time of arrival (ToA), gNB/UE Tx-RX time difference of arrival, line-of-sight (LoS) condition, and the at least one participating entity location.

### BRIEF DESCRIPTION OF THE DRAWINGS

FIG. 1 illustrates a functional framework of Artificial Intelligence/Machine Learning (AI/ML) for NR air interface.

FIG. 2 illustrates a flowchart of decision-making at an LMF when an LCS request is received.

FIG. 3 illustrates possible relations between features and AI/ML Functionalities.

FIG. 4 illustrates different categories of AI/ML functionalities.

FIG. 5 illustrates generic signaling for UE-sided AI/ML model inference.

FIG. 6 illustrates LPP signaling for UE-sided AI/ML model inference.

FIG. 7 illustrates generic signaling for LMF-sided AI/ML model inference.

FIG. 8 illustrates LPP/NRPPa signaling for LMF-sided AI/ML model inference.

FIG. 9 illustrates generic signaling for gNB-sided AI/ML model inference.

FIG. 10 illustrates NRPPa/LPP signaling for gNB-sided AI/ML model inference.

FIG. 11 illustrates signaling diagram for model training with LMF involvement.

FIG. 12 illustrates signaling diagram for ground truth label collection at the UE.

FIG. 13 illustrates signaling diagram for ground truth label collection at the gNB.

FIG. 14 illustrates signaling diagram for NF-sided training with data collection at the UE.

FIG. 15 illustrates signaling diagram for NF-sided training with data collection at the gNB.

FIG. 16 illustrates signaling diagram for LMF-sided training with data collection at the UE.

FIG. 17 illustrates signaling diagram for LMF-sided training with data collection at the gNB.

FIG. 18 illustrates signaling diagram for gNB-sided training with data collection at the UE.

FIG. 19 illustrates signaling diagram for gNB-sided training with data collection at the gNB.

FIG. 20 illustrates signaling diagram for UE-sided training.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The integration of artificial intelligence/machine learning (AI/ML) and the related use cases have seen tremendous progress in the advanced stages of the 5^{th} generation (5G) wireless communication and is expected to be a leading research domain in the upcoming 6^{th} generation (6G) technology. Present invention focuses on the potential impact of AI/ML-based approaches in positioning services for user equipment (UE). The signaling aspects regarding the inference and training phases for the positioning estimation using AI/ML algorithms for a standard-driven approach is the core concept. The AI/ML algorithms can be used to estimate the UE location directly (direct AI/ML) or assist the legacy positioning methods (AI/ML-assisted) with enhanced measurements. Present invention considers the inference and training procedures of the AI/ML models implemented at the UE, the location and management function (LMF), and the gNodeB (gNB).

Data collection is a function that provides input data for model training, management, and inference functions. Model training is a function that performs AI/ML model training, validation, and testing which may generate model performance metrics which can be used as part of the model testing procedure.

Model training function is also responsible for data preparation (e.g., data pre-processing and cleaning, formatting, and transformation) based on training data delivered by a data collection function, if required.

Management is a function that oversees the operation (e.g., selection/(de) activation/switching/fallback) and monitoring (e.g., performance) of AI/ML models or AI/ML functionalities. This function is also responsible for making decisions to ensure the proper inference operation based on data received from the data collection function and the Inference function.

Inference is a function that provides outputs from the process of applying AI/ML models or AI/ML functionalities, using the data that is provided by the data collection function (i.e., Inference Data) as an input. The Inference function is also responsible for data preparation (e.g., data pre-processing and cleaning, formatting, and transformation) based on inference data delivered by a data collection function, if required.

Model storage is a function responsible for storing trained/updated models that can be used to perform the Inference function.

The application of AI/ML in positioning along with accuracy enhancement is categorized into direct AI/ML positioning and AI/ML assisted positioning. In direct AI/ML positioning, the output of the AI/ML model is the location of the UE. For example, fingerprinting based on channel observation as the input of AI/ML model. In the case of AI/ML assisted positioning, the output of the AI/ML model is a new measurement and/or enhancement of the existing measurement. Line of sight (LoS)/Non-line of sight (NLoS) identification, timing and/or angle of measurement, and likelihood of measurement are some of the examples.

The AI/ML model(s) may be located on the UE-side, the LMF-side or the gNB-side. Similarly, the positioning computation may be performed either as UE-based, gNB-based, or LMF-based. The LMF-based computation may be either UE-assisted or next generation random access network (NG-RAN) node-assisted. Based on the above criteria, different positioning enhancement use cases could be identified, as shown in below Table 1.

TABLE 1
Positioning accuracy enhancement use cases

| | | AI/ML | AI/ML | Positioning |
|---|---|---|---|---|
| | Positioning | inference | positioning | methods |
| Case | computation | location | type | supported |
| 1 | UE-based | UE-side | Direct | AI/ML Methods |
| 2a | UE-assisted/ | UE-side | Assisted | DL-TDOA, DL-AoD, |
| | LMF-based | | | Multi-RTT, NR |
| | | | | E-CID |
| 2b | UE-assisted/ | LMF-side | Direct | AI/ML Methods |
| | LMF-based | | | |
| 3a | NG-RAN node | gNB-side | Assisted | Multi-RTT, NR |
| | assisted | | | E-CID, UL-TDOA, |
| | | | | UL-AoA |
| 3b | NG-RAN node | LMF-side | Direct | AI/ML Methods |
| | assisted | | | |

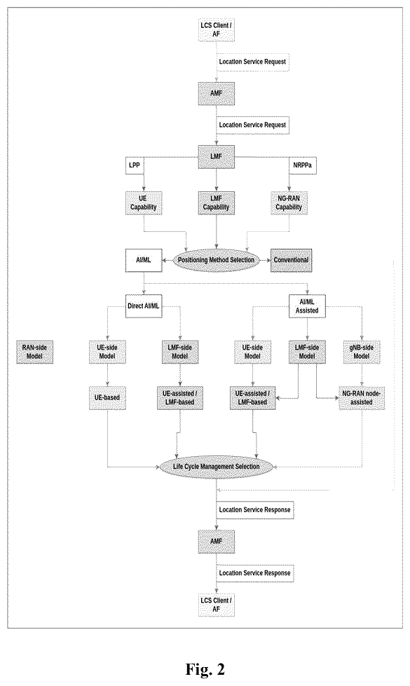

FIG. 2 illustrates a flowchart of decision-making at an LMF when an LCS request is received. The location service (LCS) client or application function (AF) is an entity that interacts with the gateway mobile location center (GMLC). It can be on the UE side, NW side, or an external third-party client. The LCS client/AF, if it is not on the UE side, can request location information of one or multiple target UEs to the access and mobility management function (AMF) via GMLC. If the LCS client/AF is on the UE side, the UE can send the location request to the AMF via uplink non-access stratum (NAS) transport. The request can include the required quality of service (QoS) (e.g. accuracy, response time, LCS QoS Class), the requested maximum age of location, the requested type of location (e.g. “current location”, “current or last known location”), etc.

The AMF, after the reception of the LCS request, selects an appropriate LMF based on the requirements in the LCS request and forwards the LCS request to the LMF. The AMF can also provide the UE capabilities and the NG-RAN capabilities.

The LMF can request the UE capabilities via the LTE positioning Protocol (LPP) request capability message, if this information is not provided by the AMF prior. Similarly, the LMF can request the NG-RAN capabilities via the NR positioning protocol A (NRPPa) signalling. Based on the UE and NG-RAN capability information and the LMF's own capability information, the LMF can decide whether to opt for the conventional positioning method or the AI/ML-based positioning method including the AI/ML-assisted legacy positioning method and the direct AI/ML-based method.

If the AI/ML support is deemed feasible, the LMF decides whether to proceed with direct AI/ML or AI/ML-assisted positioning. In direct AI/ML approach, the AI/ML model is used to get the final positioning of the target UE which can be relative, absolute, distance-based ranging, and/or angle-based ranging. Whereas in the case of AI/ML-assisted positioning, at least one of the legacy positioning measurements is estimated and provided along with the other legacy positioning measurements. Such measurements could be time difference of arrival, time of arrival, reference signal time difference, relative time of arrival (RToA), angle of arrival, angle of departure, carrier phase of reference signal, carrier phase difference of reference signal, LoS/NLOS condition/probability, RSRP, measurement window of time, and/or angle, synchronization error between transmission-reception points (TRPs)/UEs, UE/TRP Tx-Rx time difference, etc. This decision primarily depends on the capabilities of the UE, the gNB, and the LMF. The capabilities can indicate the supported AI/ML functionalities, the ability to run the AI/ML model for training, inference, and/or management, the ability to collect data for the corresponding LCM operations, etc.

As indicated above in Table 1, for the direct AI/ML approach, the inference location can be either UE-sided or LMF-sided. For UE-sided inference, the positioning computation is UE-based whereas for LMF-sided inference, the positioning computation is UE-assisted or NGRAN-assisted which can be called LMF-based. Similarly, for the AI/ML-assisted approach, the inference location can be at the UE side, the LMF side, or the gNB side. In UE-sided inference, the positioning computation is UE-assisted/LMF-based, while for the gNB-sided inference, the positioning computation is NG-RAN node-assisted. For LMF-sided inference, the positioning computation can be either UE-assisted/LMF-based or NG-RAN node-assisted.

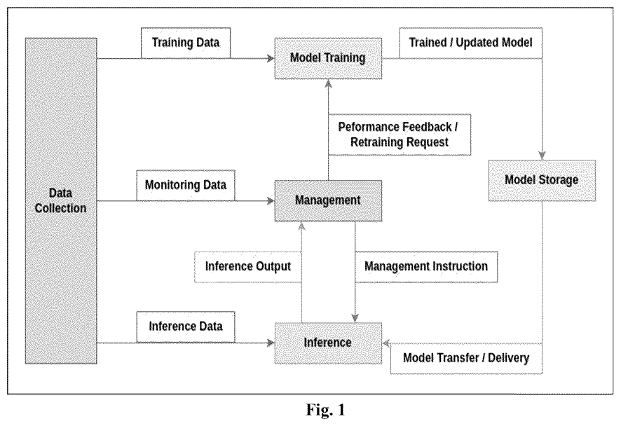

Once the AI/ML-based approach is decided by the LMF for localization of one or more UEs, it needs to select an appropriate life cycle management (LCM) of the AI/ML functionality which maintains one or more AI/ML model related to the positioning method evoked by the LMF. The fundamental LCM framework is shown in FIG. 1. The LCM procedure takes care of the AI/ML model training, AI/ML data collection for model training, model storage/transfer, and model monitoring and performance estimation and retraining. There can be multiple AI/ML models within one LCM and there can be multiple LCMs available to choose from for a given AI/ML functionality i.e. one LCM for the AI/ML model for different geographical terrains, one LCM for each legacy method positioning measurement estimation, etc. The LMF selects the most fitting LCM according to the chosen AI/ML method and the corresponding applicable functionalities. A particular LCM can serve multiple LCS requests and can also support multiple AI/ML models. Model training, model storage, model delivery/transfer, inference, model/functionality monitoring, and model/functionality control functions can be mapped to different combinations of physical entities for different AI/ML models. The LCM operation for each of the AI/ML positioning use cases shall be covered in the later sections.

The inference output for the direct AI/ML method is the location estimate while for the AI/ML assisted method, it can be new measurement(s) or existing measurement(s) enhancement, respectively. The entity that executes the inference function reports the output to the LMF. The LMF, depending upon the inference output, forms the location service response message and sends it to the AMF. The AMF subsequently forwards the same to the corresponding LCS client/AF that requested the location information.

There can be one special positioning use case which does not involve the LMF. It is labelled as UE-assisted/NG-RAN node-assisted positioning with gNB-side model. This can be considered as a completely RAN-based positioning method. Unlike the other cases, this is classified as a RAN feature with no or less involvement of the core network. The main objective is for the network to be aware of the UE location to serve it in a more optimized manner irrespective of the RRC states (Idle/Active/Inactive). This AI/ML model shall be fully under the control of the RAN. This method shall find useful applications in efficient beam management, optimal network planning, mobility enhancements, surveying, etc. In this case the model will be trained either in gNB or in OAM functionality. In case when multiple gNBs are needed to train the model, the individual gNB will exchange the training data to the OAM or the training gNB using the OAM interface or the interface between gNBs i.e. X2, Xn etc. The gNB will configure the UE for appropriate signalling for inference, training, data collection, and model monitoring.

The inference procedure for the selected AI/ML-based method for the UE by the LMF and the Model training procedure under the LCM framework will be performed independently. Based on the capability of the UE, the gNB (NG-RAN) and the LMF, the appropriate LCM and the AI/ML model from that LCM are selected for inference purposes.

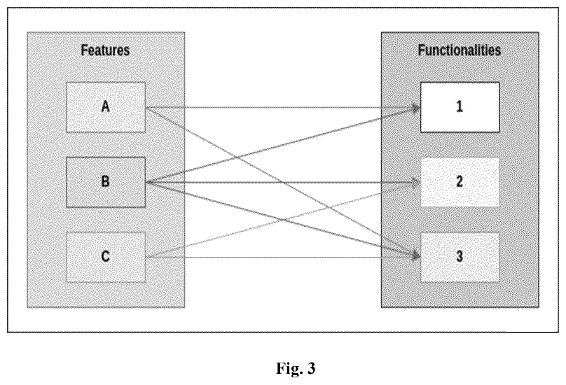

FIG. 3 illustrates possible relations between features and AI/ML functionalities. The AI/ML functionality refers to an AI/ML-enabled feature or feature group enabled by configuration(s), where the configuration(s) is (are) supported based on the conditions indicated by the UE capabilities or NW capabilities. AI/ML functionality can be thought of as a set of features that characterizes an AI/ML model. The features can be input, output, supporting conditions, scenarios, etc.

Consider an example where there are three AI/ML features A, B, and C. Any valid combination of these features can constitute functionality. For instance, functionality 1 is characterized by features A and B, functionality 2 by B and C, and lastly, functionality 3 by features A, B, and C. Some of the features and additional conditions are listed below in Table 2. The combination of the features below forms the functionality. For each functionality, there can be one or more models available. The applicability of the model depends on the conditions in which the model is valid, called additional conditions.

TABLE 2
AI/ML feature list and additional conditions

| | | Additional | |
|---|---|---|---|
| Feature List | | Conditions | |
| Type of inputs | Channel impulse | Beam parameters | Beam assumptions, |
| | response (CIR), | | beamwidth, timing |
| | Power delay profile | | errors, |
| | (PDP) | | synchronization |
| | | | error, orientation of |
| | | | TX and RX antennas, |
| | | | Quasi Co Location |
| | | | (QCL) type |
| | | | assumptions and |
| | | | QCL reference |
| | | | signals (RS) |
| Number of inputs | | | |
| Input hyper- | Reference node | Geographical | Terrain of training, |
| parameters | location, initial phase, | condition, Ambient | indoor, outdoor |
| | reference | temperature (range) | |
| | time/slot/symbol | | |
| Type of output | Absolute location, | TX/RX velocity | |
| | relative location, | | |
| | Positioning | | |
| | measurements | | |
| | including TOA, | | |
| | RSTD, RTOA, Rx-Tx | | |
| | time difference of | | |
| | arrival, AoD, AoA, | | |
| | carrier phase | | |
| | measurements, time | | |
| | synchronization | | |
| | information, | | |
| | LOS/NLOS | | |
| | indication/probability. | | |
| Bandwidth and | | | |
| subcarrier spacing | | | |
| (in case of CIR), | | | |
| sampling rate | | | |
| Antenna parameters | | TX power | Applicable power |
| | | | under power control |
| Carrier frequency | | | |
| range | | | |

For illustration purposes, the absolute location estimation of a UE with the help of AI/ML can be considered as an AI/ML functionality. Therefore, the feature here can be specific measurements like AoA, AoD, LOS/NLOS, etc. Further, the AI/ML mode to be selected may be dependent on the conditions at the UE and the network end (including gNB/TRP and LMF). These conditions are called additional conditions as mentioned in above Table 2. Thus, the combination of features constitutes functionality of AI/ML and such functionality with additional conditions decides the AI/ML model to be used for inference. Similarly, the different combinations of functionalities with additional conditions are associated with the specific LCM cycle under which the AI/ML model is being trained and monitored.

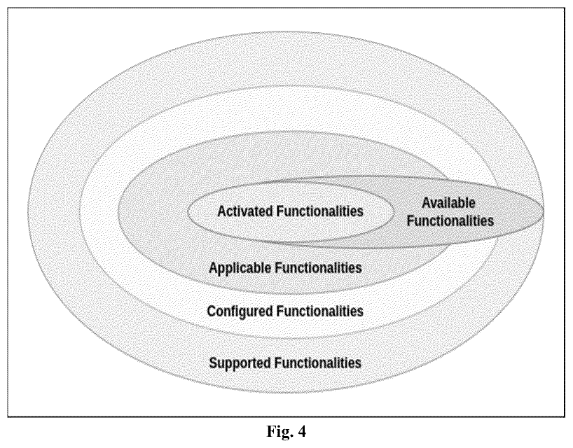

FIG. 4 illustrates different categories of AI/ML functionalities. Supported functionalities refer to the functionalities that the UE is capable of. This can be indicated to the network as UE capability or LPP capability information. Functionality being supported doesn't imply that the respective model is available with the UE but indicates the UE has the capability to perform the functionality. If the model is available, it can be considered as available functionality. If the model is unavailable, the gNB/LMF can still configure the functionality(s) to the UE, if the gNB/LMF supports the corresponding functionality(es). Model is unavailable could mean that model training is not started, training is not completed, and/or the model is not fetched from the model storage entity. When the gNB/LMF requests capability from the UE, the gNB/LMF may ask for all the supported functionalities or the set of supported functionalities that are configurable by the gNB/LMF depending upon the use cases. The supported functionalities can be indicated with a functionality identifier. The functionality identifier can be assigned by either the LMF or the UE.

Configured functionalities refer to the functionalities that the gNB/LMF has configured to the UE. However, getting configured by the gNB/LMF doesn't imply that the corresponding functionality(es) is (are) applicable. The condition for applicability varies depending upon multiple factors, viz., operating scenario, terrain, environmental conditions, UE capability, gNB/LMF capability, etc. Configured functionality does not mandate that the model is available at the UE. The gNB/LMF can configure a UE for functionality even if the model is not available in the UE. In other words, the gNB/LMF does not consider the model availability condition while configuring the AI/ML functionalities. The model can be made available by model transfer/delivery from the model storage entity. The LMF is expected to maintain the corresponding functionality identifiers while configuring the respective functionalities.

Applicable functionalities refer to the functionalities that the UE can use for inference. Applicable functionalities can be considered as candidates for functionality activation/switching/deactivation. Applicable functionality is determined based on the scenarios, locations, configuration, and deployments, among other factors, and the UE reports it to the gNB/LMF either reactively or proactively. In reactive reporting of UE-sided applicable functionality(es), the gNB/LMF may request for the applicable functionality(es) and the UE provides the relevant information in response via UAI/LPP message. In proactive reporting, the UE reports its applicable AI/ML functionalities unsolicited via UAI/LPP message. While the UE reports the applicable functionalities, it is expected to use the corresponding functionality identifiers to maintain consistency. If the model is available in the UE and applicable, it can be applied to the model inference straightaway. If the model is not available, the UE can request the model transfer/delivery from the appropriate entity (model storage entity). There could further be scenarios where the functionalities that are not configured by the network can be applicable to the UE. This mostly falls under proprietary functionalities specific to the UE.

Applicable functionalities are a subset of the configured functionalities. Suppose a UE is configured with functionalities that are not applicable under certain conditions but may be applicable under certain other conditions. In that case, the functionality activating/switching/deactivating feature can be seamlessly performed using the configured functionality list. The UE need not wait for the configurations from the gNB/LMF to activate the newly applicable functionality. However, it is up to the gNB/LMF whether the configuration shall be provided to the UE before determining the applicable functionalities. In such scenarios, the applicable functionalities and the configured functionalities would be the same.

Activated functionalities refer to the functionalities that the UE is using for inference. Activated functionalities are a subset of applicable functionalities. The UE shall indicate the currently activated functionalities to the gNB/LMF and if any switching/deactivation is performed, it shall be informed to the gNB/LMF, if required. The corresponding functionality identifiers are used for any reporting or configurations.

The model availability is not mandated until the stage of inference. Once the applicable functionalities are decided at the UE end, the UE can opt for means to obtain the required model(s) from the OTT server, LMF, gNB, CN, or OAM, if not already available with the UE. If UE has multiple applicable models available or transferred from external entities, it can decide which one to use for inference.

Available functionalities refer to the functionalities for which the UE already has model(s) with it. A model available does not imply it is configured/applicable/activated. It shall just indicate the respective functionality supported but not vice versa. If a functionality has multiple models, model identifiers are used to uniquely identify them. Similarly, if a model can be associated with multiple functionalities, functionality identifiers can be used.

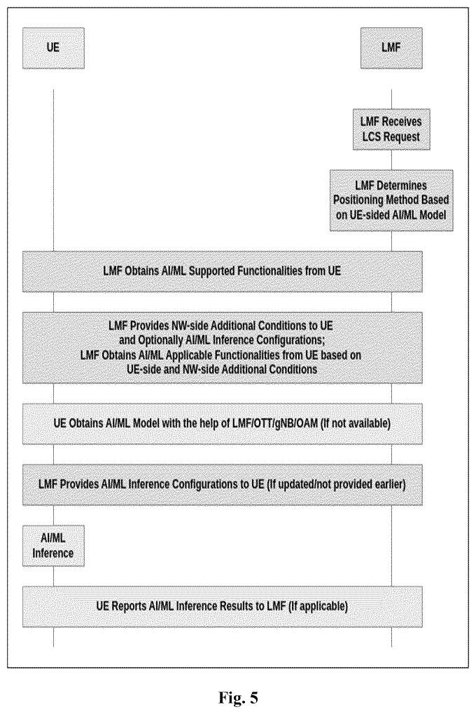

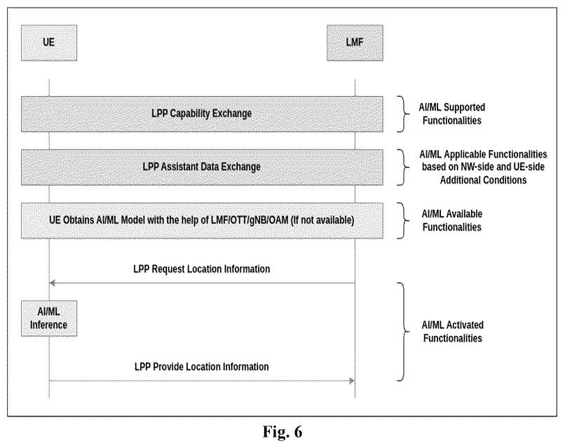

FIG. 5 and FIG. 6 illustrate different signaling flows for inferences at UE-side models. Specifically, FIG. 5 illustrates generic signaling for UE-sided AI/ML model inference. As shown in FIG. 5, upon receiving LCS request from an AMF, the LMF will decide on the positioning method. For doing so, the LMF establishes an LPP connection towards the UE and NRPPa link towards the gNB/TRP (serving the target UE) to gather the capabilities of the UE and the TRP/gNB. The LMF sends the LPP RequestCapability message to the UE and the NRPPa TRPCapabilityRequest to the gNB/TRP to obtain the AI/ML capability. The AI/ML capability message includes the supporting functionalities and features towards the positioning estimation using the AI/ML model. This will include positioning measurement estimation features/capabilities like TDoA, RTOA, AoA, AoD, ToA, etc, assisting measurement to legacy positioning measurements like LOS/NLOS, RSRP, synchronization errors, measurement windows, path powers, path phases, etc., or direct position of the target UE and/or angular/distance range of the UE with a fixed reference using the AI/ML models. This also includes the AI/ML model availability flag for each of the features mentioned above. This can be a Boolean bit map corresponding to the features. Further, it can also include possible model parameters like model accuracy, model retraining capability, retaining time duration, possible model availability time, etc. The UE and the TRP will report all such supporting functionalities using the ProvideCapability message over LPP and the TRPCapabilityResponse message using NRPPa, respectively. The LPP RequestCapability and the NRPPa TRPCapabilityRequest messages will be requesting the availability of the features as a Boolean query. Whereas, the LPP ProvideCapability and the NRPPa TRPCapabilityResponse messages reply with the capability of the features along with specific information requested for the features mentioned above. The group of features form the AI/ML functionality.

Based on the capabilities carrying supported functionalities received by the LMF, the LMF will decide on one or more functionalities towards the LCS based on the positioning QoS requested in the LCS and the minimum QoS guaranteed by the functionalities (this may be provided by in capability message along with the supported functionalities). The LMF configures the selected functionalities as configured functionalities along with the NW-side additional conditions to be considered for the model selection for the configured functionalities. This can be provided in the LPP Provide AssistanceData message from the LMF to the UE. This can be an optional message if more than one supporting functionality is provided in the capability message.

FIG. 6 illustrates LPP signaling for UE-sided AI/ML model inference. The UE will receive these configured functionalities and additional conditions and select the applicable functionalities based on the matched additional conditions both at the UE-side and network-side conditions. These applicable functionalities will be reported to the LMF using proactive or reactive messaging. In the case of the proactive approach, the UE will initiate the message in an unsolicited manner using the LPP Provide Assistance Data message from the UE to the LMF. Whereas in the reactive case, the UE will provide the response in LPP ProvideAssistanceData message to the message containing configured functionality or a separate request for the applicable functionality provided by the LPP RequestAssistance Data message from the LMF to the UE. The UE can provide the model availability flag along with the applicable functionality report.

Alternatively, this can be performed in the capability message exchange itself. The LPP RequestCapability and the NRPPa TRPCapabilityRequest messages will carry the additional conditions mentioned in Table 2 provided above. The UE will provide the capabilities considering the NW-side additional conditions in the LPP ProvideCapability and the NRPPa TRPCapabilityResponse messages.

The LMF receives these applicable functionalities and the model availability flag. The LMF selects the applicable functionality for the list of reported applicable functionality. If the model is not available at the UE, then the LMF either provides the appropriate model to the UE for inference using inference configuration if the model is available with the LMF or the LMF can fetch it from other NFs or OAM. Alternatively, if the model is available with the UE or the UE can fetch it from the over-the-top (OTT) server without the intervention of the LMF, the LMF indicates the UE to do so.

The LMF provides the necessary reference signal configuration and additional information like reference TRP, synchronization information, etc. to the UE for inference purposes. This can be provided using the LPP RequestLocationInformation message and the UE will perform the inference using the activated AI/ML functionality and the corresponding model.

The UE provides the inference result to the LMF using the LPP ProvideLocationInformation message. It may include the direct location or the intermediate positioning measurements and/or the supporting measurements like LOS/NLOS.

Alternately the LMF may calculate the UE location and estimate the achieved accuracy by using LMF-based AI/ML positioning. When receiving the request for the UE location, the LMF selects the AI/ML-assisted or the direct AI/ML-based positioning method to determine the result of the positioning. The results of the positioning may be calculated by using the LMF-based AI/ML positioning ML model supported by the LMF. The LMF collects input data from the UE or the NG-RAN for the LMF-based AI/ML positioning to perform the location calculation and provide the location to the consumer. In this case, the above steps are applicable with the modification that the positioning measurement and location estimation are performed at the LMF end.

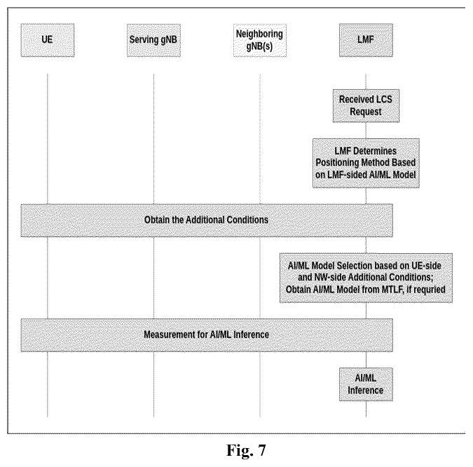

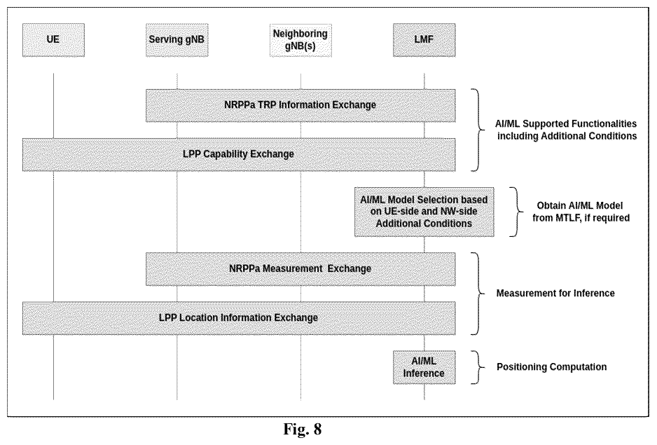

FIG. 7 and FIG. 8 illustrate signaling flows for inferences at LMF-side models. Specifically, FIG. 7 illustrates generic signaling for LMF-sided AI/ML model inference, and FIG. 8 illustrates LPP/NRPPa signaling for LMF-sided AI/ML model inference. Upon receiving the LCS request from the AMF, the LMF will decide on the positioning method. For doing so, the LMF establishes an LPP connection towards the UE and a NRPPa link towards the gNB(s)/TRP(s) to gather the capabilities of the UE and the gNB(s)/TRP(s). Once the LMF decides to use the positioning method based on the LMF-based AI/ML model, the LMF selects a suitable AI/ML model either from its repository or gets it transferred from the MTLF, in accordance with the NW-side and UE-side additional conditions. The gNB(s) performs the measurements with the UE and transfers them to the LMF for the AI/ML model inference to estimate the UE location.

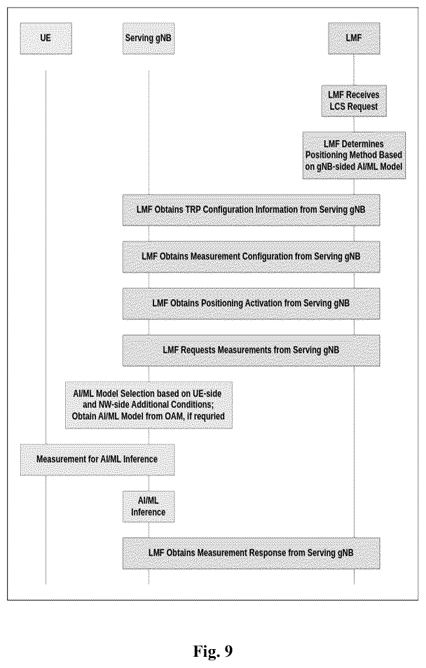

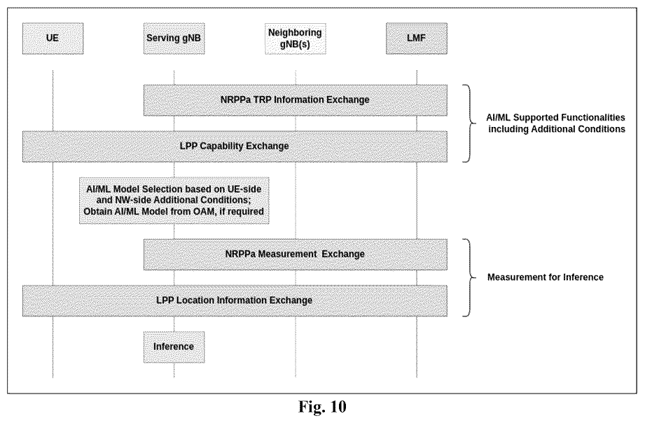

FIG. 9 and FIG. 10 illustrate signaling flows for inferences at gNB-side models. Specifically, FIG. 9 illustrates generic signaling for gNB-sided AI/ML model inference, and FIG. 10 illustrates NRPPa/LPP signaling for gNB-sided AI/ML model inference. Upon receiving an LCS request from AMF, the LMF will decide on the positioning method. For doing so, the LMF establishes an LPP connection towards the UE and a NRPPa link towards the serving gNB to gather the capabilities of the UE and the serving gNB. Once the LMF decides to use the positioning method based on the gNB-based AI/ML model, the LMF obtains the TRP configuration and measurement configuration from the serving gNB. The serving gNB configures the UE for the measurements. The LMF activates the positioning after getting confirmation from the serving gNB regarding the measurement activation at the UE end. The LMF requests for the measurements from the serving gNB. The serving gNB selects a suitable AI/ML model either from its repository or gets it transferred from the OAM, in accordance with the NW-side and UE-side additional conditions. The serving gNB performs the measurements with the UE and uses them for the AI/ML model inference to obtain the enhanced measurement parameters. The inference output is sent to the LMF, which runs the legacy positioning method to estimate the UE location.

In a model training phase, AI/ML model training will occur in parallel to the AI/ML inference procedures mentioned in the above section. Interaction with the model training and the inference procedures will be at the model recovery state from the model repository and the inference operation will be performed on the selected/recovered model. Irrespective of whether the model inference is at the UE-side, the LMF-side, or the gNB-side, the model training can run anywhere for the respective cases. There may be certain advantages in restricting the model training to specific entities depending upon the inference location, but for forward compatibility based on the capabilities of the UE, the LMF, and the gNB, the training can be designed to occur at the UE/OTT server, the LMF/MTLF, and the gNB/OAM for any of the AI/ML positioning cases.

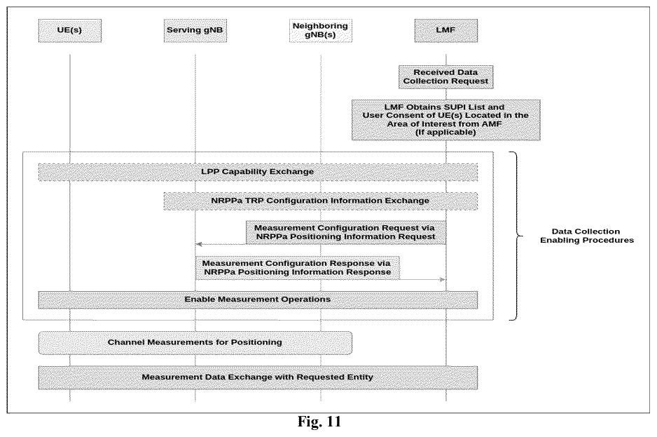

FIG. 11 illustrates generic signalling architecture of the model training phase with the involvement of the LMF. The LMF can receive a request for data collection from at least one of the entities namely the UE, the gNB, the network function (NF) like the NWDAF/MTLF, or the logical unit in the LMF itself. Upon receiving the request, if required, the LMF subscribes to the AMF to retrieve the list of SUPIs located in an area of interest and the UE Positioning Capability for each UE using Namf_EventExposure_Subscriber Request (Target of Event Reporting=“any UE”, Event ID=“UEs in/out area of interest” and “UE Positioning Capability”). The AMF sends Namf_EventExposure_Subscriber_Response (“list of SUPIs in the area of interest”). If “UE Positioning Capability” is also requested, AMF includes the UE Positioning Capability and the UE User Plane Positioning Capabilities, if available for each SUPI in the response message sent to LMF. The AMF subscription also provides the updated UE list at periodic intervals or any change in the prior list. The LMF proceeds with the data collection enabling procedures. The LMF triggers the LPP capability exchange with the UE(s) in the AoI to obtain the positioning capabilities of the UE(s), if not already available, and the NRPPa TRP information exchange with the serving gNB of the target UE(s) to obtain the list of the neighboring gNB(s) for the UE(s) from the list. If the TRP information is already available at the LMF, this operation can be skipped. Once the TRP information is available at the LMF, the LMF proceeds to request the measurement configurations such as the positioning reference signal (PRS) or any other RS configurations from the serving gNB if not already provided during the TRP information exchange, using the NRPPa Positioning Information Request message. The serving gNB provides measurement configurations (eg. PRS, SRS, CSIRS, SSB, etc.) of the neighboring gNB(s) as well as its own to the LMF, using the NRPPa Positioning Information Response message. Once the measurement configurations are available at the LMF, the LMF enables the measurement operations (eg. PRS, SRS) at the target UE(s), the serving gNB, and the neighboring gNB(s), using the LPP/NRPPa messages. The target UE(s) or the gNB(s) perform the channel measurements for the positioning and push the measurement data to the entity that requested the data collection, either directly or via the LMF, depending on the model training entity. The individual training entities shall be covered in the subsequent sections.

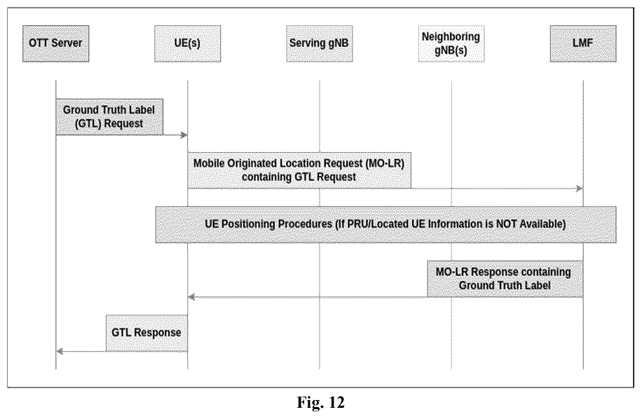

FIG. 12 illustrates signaling for ground truth label collection at the UE. For the ground truth label information at the UE-side, the UE can measure the labels to the data like the location of the UE (the absolute or relative to a predefined reference location, distance, angle in both horizontal and vertical directions, the LoS condition flag (Yes/No), and/or the time stamp measurement, etc.). The UE will push these labels along with the measurements. If the UE is not able to estimate the labels or is not configured to estimate the labels, then the positioning server i.e, the LMF or the sideline (SL) positioning server can estimate the labels and forward it to the requesting entity at the UE end.

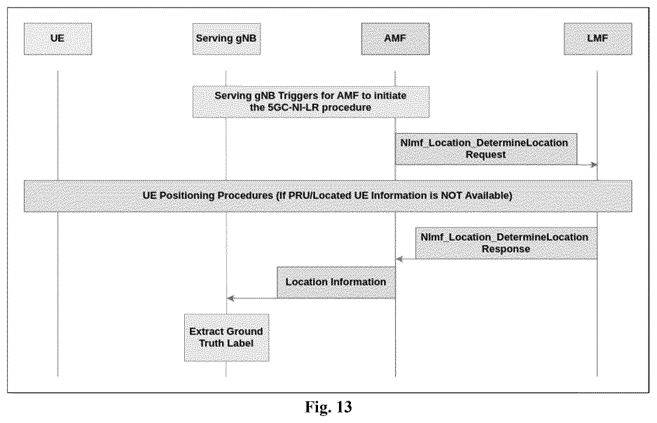

FIG. 13 illustrates signaling for ground truth label collection at the gNB. For ground truth label at the gNB-side, the gNB requests the LMF to provide the label information. The gNB triggers the AMF for a network-induced location request (NI-LR). The AMF sends the location request to the LMF. The LMF initiates the UE positioning procedures if the PRU or the located UE information is not available. The location information is sent to the AMF, which forwards the same to the serving gNB. Depending on the model running at the gNB-side, the ground truth label information is processed. If the gNB is using direct AI/ML method, where the model inference output is the estimated location, the location information label is used as it is, whereas, if the gNB is using the AI/ML-assisted method, where the model inference output is the AI/ML-enhanced measurements, the location information label needs to be processed accordingly.

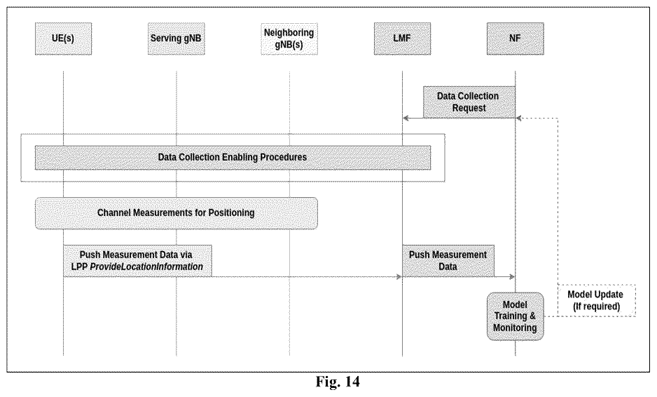

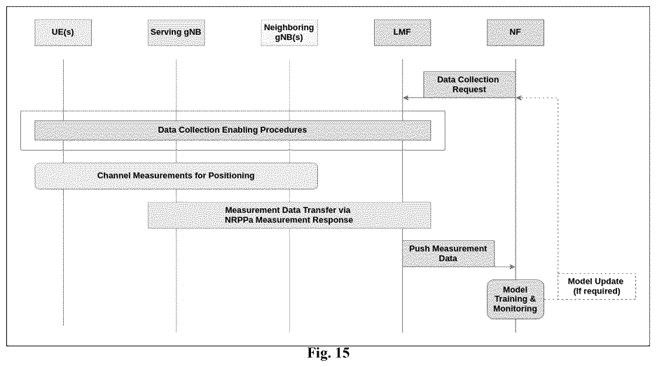

FIG. 14 and FIG. 15 illustrate different form of signaling for NF-sided training. Specifically, FIG. 14 illustrates signaling for NF-sided training with data collection at the UE, and FIG. 15 illustrates signaling for NF-sided training with data collection at the gNB. In NF-sided training, the NF or the logical function within the NF such as the network data analytical function (NWDAF), model training network function (MTNF), etc., is responsible for the model training and monitoring. The data collection enabling procedure as explained above with reference to FIG. 11, is initiated by the LMF upon receiving the request for the data collection from the NF, including the AMF subscription for the list of UE(s) in the AoI with the user consent information. Based on the measurement configurations, the UE(s) can perform the channel measurements and transfer the collected data to the LMF via the LPP ProvideLocationInformation message. Alternatively, if the channel measurements are performed at the gNB(s), the gNB(s) transfer the measurements to the LMF via NRPPa Measurement Response. Once the measurement data is received at the LMF, the LMF pushes the data to the NF, where the NF trains the model based on the functionalities. The NF monitors the model's performance periodically and provides feedback if any update to the model is required, by triggering a new data collection request to the LMF.

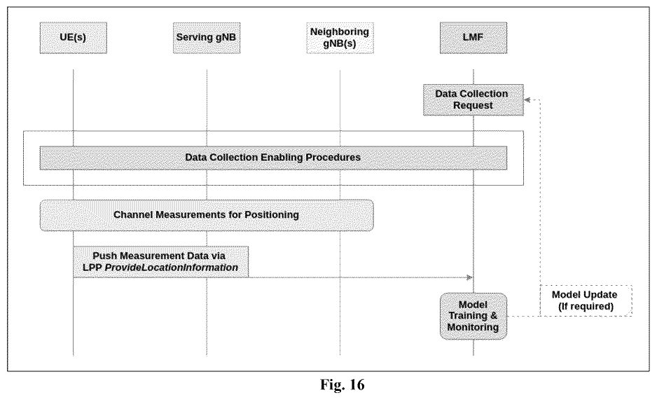

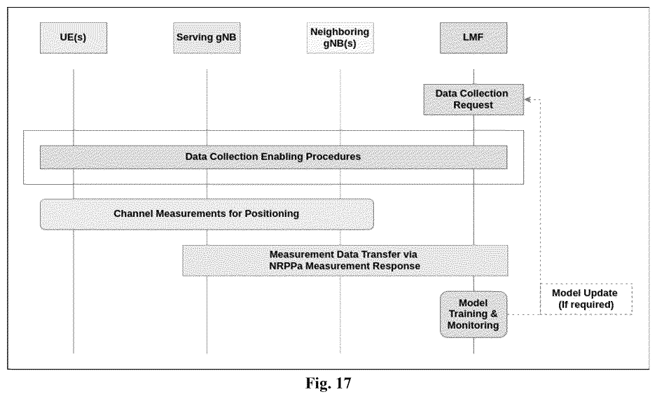

FIG. 16 and FIG. 17 illustrate signaling for LMF-sided training. Specifically, FIG. 16 illustrates signaling for LMF-sided training with data collection at the UE, and FIG. 17 illustrates signaling for LMF-sided training with data collection at the gNB. The AI/ML model used for LMF-based AI/ML positioning in LMF may be trained by the LMF e.g, the LMF may have model training logical function (MTLF) to train the model. The trigger for data collection and model training in LMF is up to implementation or may be trigger from the external NF like NWDAF. The LCS request received by LMF may trigger the model training at the LMF. The LMF can initiate the data collection enabling procedures at the UE-end as described above with reference to FIG. 11, including the AMF subscription for the list of UE(s) in the AoI with the user consent information.

The LMF can configure the data collection request to the list of UEs obtained from the AMF. This request can be an LCS request indicating the data collection. This request will be associated with one of the LCMs running in the LMF which can be indicated by the associated ID (model ID and/or LCM ID). The LMF determines the UEs from the list of SUPIs that received from AMF for data collection to train the AI/ML based positioning model based on UE Positioning Capability, UE User Plane Positioning Capabilities, UE consent check result, the PRU information available in the LMF and operator's policy. For each UE that provides consent to data collection for model training and can support data collection the LMF initiates a request for input data.

Based on the measurement configurations, the UE(s) can perform the channel measurements and transfer the collected data to the LMF via the LPP ProvideLocationInformation message. Alternatively, if the channel measurements are performed at the gNB(s), the gNB(s) transfer the measurements to the LMF via NRPPa Measurement Response. Once the measurement data is received at the LMF, the LMF gathers the data collected from the various UEs and trains the models based on the functionalities. The model training keeps running in the LMF periodically as more and more UEs may push the measurement data at various intervals. The models are made available to be downloaded as per the request from the UEs. The LMF monitors the model's performance periodically and provides feedback if any update to the model is required, by initiating a new data collection signaling procedure.

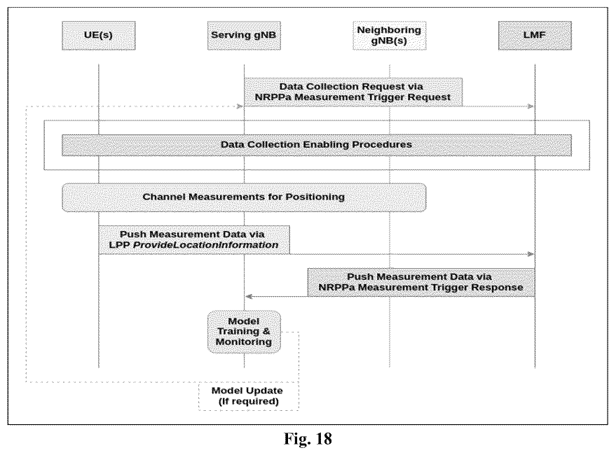

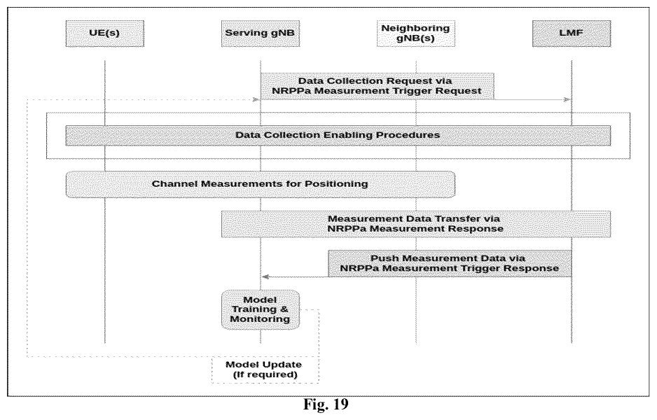

FIG. 18 and FIG. 19 illustrate different forms of gNB-sided training. Specifically, FIG. 18 illustrates signaling diagram for gNB-sided training with data collection at the UE, and FIG. 19 illustrates signaling diagram for gNB-sided training with data collection at the gNB. As illustrated, the serving gNB of the target UE(s) performs the model training and monitoring. Based on the feedback from the model monitoring unit, the gNB can decide to update the trained model and if required, can request the LMF to enable data collection, using the NRPPa measurement trigger request message. The LMF, upon receiving the request from the gNB, initiates the data collection enabling procedures, as explained above with reference to FIG. 11, including the AMF subscription for the list of UE(s) in the AoI with the user consent information. Based on the measurement configurations, the UE(s) can perform the channel measurements and transfer the collected data to the LMF via the LPP ProvideLocationInformation message. Alternatively, if the channel measurements are performed at the gNB(s), the gNB(s) transfer the measurements to the LMF via NRPPa Measurement Response. Once the measurement data is received at the LMF, the LMF pushes the data to the serving gNB of the target UE(s), using the NRPPa Measurement Trigger Response message. The gNB trains the model using the collected data and monitors the performance periodically. If any update is required to the model, the gNB triggers feedback by sending a new data collection request to the LMF.

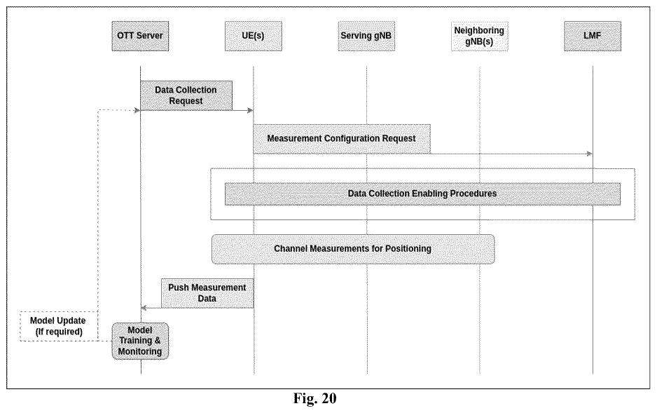

FIG. 20 illustrates signaling diagram for UE-sided training. For the UE-sided training, the UE/OTT server performs model training and monitoring. The OTT server can be within the UE. The OTT server is a server for training the models and may have repositories to store the training data and the trained model. It may have model monitoring functionality too. It shall provide subscriptions to a large number of UEs for training the data collected by all the subscribed UEs. These subscriptions can be managed in a network non-transparent manner or network transparent manner. In the case of the network non-transparent manner, the UE list is provided to the OTT by the network through the network function-based interface.

For the data collection procedure, the UE(s) shall receive a request for the data collection from the OTT server, the NF, or the logical function with the NF to initiate the data collection procedure. The UE(s) then forwards the request to the LMF via the LPP message, e.g., supplementary signaling (SS) message with the LPP container. The LMF, upon receiving the request from the UE(s), initiates the data collection enabling procedures, as explained above with reference to FIG. 11. The data collection includes the positioning measurements as input to the training model and the label to compare the output, based on which the feedback is sent to trigger the model training process. The positioning measurement includes the RSRP, the channel impulse response/power delay profile in terms of sample amplitude, the tap amplitude, the sample time, the sample index, and the sample phase. The label may include the absolute location or relative location to a predefined reference, distance, angle in both horizontal and vertical directions, LOS condition flag (Yes/No), and/or time stamp measurement, etc.

The LMF configures the UE(s) for the measurements using the LPP message like Provide AssistanceData or RequestLocationInformation. The LMF may expect no reply to the request message or may receive a reply with the confirmation of the transfer of measurements to the OTT server. This request can be set for periodic measurements and the LMF may receive the acknowledgment for the same upon transmission of the measurement to the OTT server. In case of an unsuccessful event, the UE may report the failure message to the LMF. Based on this, the LMF takes appropriate corrective measures upon receiving the failure message which includes removing the UE from the data collection configuration list and indicating the same to the UE. Based on the configurations, the UE(s) can perform the channel measurements and transfer the collected data to at least one of the OTT servers. The OTT server gathers the data collected from the various UEs and trains the models based on the functionalities. The model training keeps on running in the OTT server periodically as more and more UEs may push the measurement data at various intervals. The models are made available to be downloaded with or without the help of the LMF as per the request from the UEs. The model monitoring is done at the model training entity and provides feedback if any update to the model is required, by triggering a new data collection request to the UE(s). Model monitoring will be performed based on the inference outcome of the trained model in the OTT server. Based on the predefined criteria or metric of model performance, the OTT server will select the model for retraining, and the above procedure is repeated to retrain the model. The UE provides the inference output to the OTT server for performance monitoring.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

We claim:

1. A method of positioning in a wireless communication network, the method comprising:
receiving, by a user equipment (UE), an LTE positioning protocol (LPP) signaling from a location management function (LMF);
transmitting, by the UE, at least one capability message, wherein the at least one capability message indicates support for at least one AI/ML model for at least one first positioning estimation functionality;
receiving, by the UE, at least one configuration from the LMF;
performing, by the UE, AI/ML inference of at least one of UE location estimate and measured features using the at least one AI/ML model based on at least one second positioning estimation functionality and reference signal configurations; and
transmitting, by the UE, at least one of UE location estimate and measured features, to the LMF.

2. The method as claimed in claim 1, wherein the first positioning estimation functionality comprises at least one of time difference of arrival (TDoA), angle of arrival (AoA), angle of departure (AoD), time of arrival (ToA), and received signal power metrics.

3. The method as claimed in claim 1, wherein the LPP signaling from the LMF comprises at least one capability signaling and assistance data signaling.

4. The method as claimed in claim 1, wherein the at least one configuration comprises indicating at least one third positioning estimation functionality from the at least one first positioning estimation functionality based on network-side conditions.

5. The method as claimed in claims 1 and 4, wherein the at least one second positioning estimation functionality is selected from the at least one third positioning estimation functionality in accordance with at least one of network-side and UE-side conditions, and
reporting the at least one second positioning estimation functionality to the LMF.

6. The method as claimed in claim 1, wherein the at least one AI/ML model comprises at least one attribute, and wherein the at least one attribute comprises at least one of model accuracy, retraining capability, and availability time duration.

7. The method as claimed in claim 1, wherein the UE receives the AI/ML model from at least one of the LMF and an over-the-top (OTT) server.

8. The method as claimed in claim 1, wherein the UE performs inference in one of a proactive manner by autonomous reporting and a reactive manner in response to an LMF query.

9. A method for determining a location of a User Equipment (UE) using an artificial intelligence/machine learning (AI/ML) model, the method comprising:
receiving, by a location management function (LMF), a location service (LCS) request from an access and mobility management function (AMF);
establishing, by the LMF, a communication link with at least one of the UE, a serving transmission/reception point (TRP) and at least one neighboring TRP;
determining, by the LMF, a suitable positioning method and an LMF-side AI/ML model;
obtaining, by the LMF, at least one positioning measurement data from at least one of the UE, the serving TRP and neighboring TRPs;
performing, by the LMF, an AI/ML model inference using the at least one positioning measurement data to estimate the UE location; and
providing, by the LMF, the UE location estimate to an LCS consumer.

10. The method as claimed in claim 9, wherein the suitable positioning method is one of TDoA, RToA, AoA, AoD, multi-round trip time (m-RTT), and carrier phase-based.

11. The method as claimed in claim 9, wherein the UE location estimate further comprises positioning measurement data derived from the UE location.

12. The method as claimed in claim 9, wherein the communication link is one of link established between the LMF and the UE, and the link established between the LMF and one of the serving TPR and the neighboring TRP.

13. The method as claimed in claim 12, wherein the link established between the LMF and the UE uses LTE positioning protocol (LPP), and the link established between the LMF and one of the serving TPR and the neighboring TRP uses one of NR positioning protocol (NRPPa) and LPPa.

14. The method as claimed in claim 11, wherein the positioning measurement derived from the UE location comprises at least one of LOS condition, ToA, carrier phase of arrival, AoA, and AoD.

15. The method as claimed in claim 9, wherein the AI/ML model is received from at least one of a model repository and a model training logical function (MTLF).

16. The method as claimed in claim 9, wherein the at least one positioning measurement data comprises at least one of time difference of arrival (TDoA), relative time of arrival (RToA), angle of arrival (AoA), angle of departure (AoD), time of arrival (ToA), gNB/UE Tx-RX time difference of arrival, synchronization information, path phase, RSRP, measurement windows, path powers, and line-of-sight (LoS) condition.

17. A method for performing positioning inference using an AI/ML model, the method comprising:
receiving by a base station (BS), a request from a location management function (LMF) to initiate an AI/ML-based positioning procedure;
configuring, by the BS, to obtain at least one channel measurement data for a user equipment (UE);
receiving, by the BS, the at least one channel measurement data from the UE;
performing, by the BS, an inference using a gNB-side AI/ML model and the at least one channel measurement data to estimate at least one of, the estimate of UE location parameter and at least one positioning measurement parameter; and
transmitting, by the BS, at least one of the UE location parameters and at least one positioning measurement parameter to the LMF.

18. The method as claimed in claim 17, wherein the gNB receives the AI/ML model from at least one of the LMF and an operations and management (OAM) server.

19. The method as claimed in claim 17, wherein the at least one channel measurement data comprises at least one of path power, channel impulse response, path delays, path phase and path angles (AoD/AoA).

20. The method as claimed in claim 17, wherein the at least one positioning measurement parameter include at least one of multipath delays, time difference of arrival (TDoA), relative time of arrival (RToA), angle of arrival (AoA), angle of departure (AoD), time of arrival (ToA), gNB/UE Tx-RX time difference of arrival, synchronization information, path phase, RSRP, measurement windows, path powers, and line-of-sight (LoS) condition.

21. A method for training an AI/ML model in a wireless positioning system, the method comprising:
receiving, by a location management function (LMF), a data collection request from at least one entity among a user equipment (UE), base station (BS), or a network function (NF);
subscribing, by the LMF, to an access and management function (AMF) to obtain at least one participating entity within an area of interest;
receiving, by the LMF, the at least one participating entity;
configuring, by the LMF, at least one positioning measurement reporting from at least one participating entity using at least one of LPP and NRPPa signaling;
obtaining, by the LMF, at least one of, at least one positioning measurement data and corresponding ground truth label (GTL) data from the at least one of UE and gNB; and
forwarding, by the LMF, at least one of, at least one positioning measurement data and corresponding ground truth label (GTL) data to a designated training entity for AI/ML model training.

22. The method as claimed in claim 21, wherein the at least one participating entity comprises positioning capabilities.

23. The method as claimed in claim 21, wherein the BS is one of gNB, eNB, ng-eNB, and 6 gNB.

24. The method as claimed in claim 21, wherein the at least one participating entity is at least one user equipment (UE), or customer premise equipment (CPE).

25. The method as claimed in claim 21, wherein the at least one participating entity is identified using at least one of user equipment identifiers, subscription permanent identifier (SUPI), subscriber concealed identifier (SUCI), 5G globally unique temporary identity (5G-GUTI), permanent equipment identifier (PEI), and generic public subscription identifier (GPSI).

26. The method as claimed in claim 21, wherein the designated training entity is one of the BS, the UE, network data analytics function (NWDAF), model training and learning function (MTLF), operation and management (OAM) entity or external data collection server.

27. The method as claimed in claim 21, wherein the at least one positioning measurement data is at least one of path power, channel impulse response, path phase multipath delays, time difference of arrival (TDoA), relative time of arrival (RToA), angle of arrival (AoA), angle of departure (AoD), time of arrival (ToA), gNB/UE Tx-RX time difference of arrival, synchronization information, path phase, RSRP, measurement windows, path powers, and line-of-sight (LoS) condition.

28. The method as claimed in claim 21, wherein the at least one GTL data is at least one of time difference of arrival (TDoA), relative time of arrival (RToA), angle of arrival (AoA), angle of departure (AoD), time of arrival (ToA), gNB/UE Tx-RX time difference of arrival, line-of-sight (LoS) condition and the at least one participating entity location.

29. The method as claimed in claim 21, wherein the designated training entity trains at least one positioning AI/ML model based on the at least one positioning measurement data and at least one ground truth label received from the LMF and provides indication to initiate new data collection when model performance degradation is detected.

30. The method as claimed in claim 21, wherein the training is performed by at least one BS utilizing at least one of, at least one positioning measurement data and at least one GTL data received from the LMF via an NRPPa Measurement Trigger Response message.

31. The method as claimed in claim 21, wherein the training is performed by an LMF-integrated model training logical function (MTLF) triggered upon receiving an LCS request.

32. A method implemented at a User Equipment (UE) or associated over-the-top (OTT) server for training an AI/ML model for positioning estimation, the method comprising:
receiving, by at least one UE, a data collection request from a training entity in OTT server;
collecting, by at least one UE, at least one of at least one channel measurement data and at least one positioning measurement data;
associating, by at least one UE, the positioning measurements with at least one ground truth label; and
transmitting, by at least one UE, the at least one positioning measurement data and at least one ground truth label to the OTT server.

33. The method as claimed in claim 32, wherein method further comprises:
training, by the OTT server, at least one AI/ML model for UE positioning, using the at least one positioning measurement data and at least one ground truth label; and
periodically monitoring by the OTT server, model performance and initiating retraining as required.

34. The method as claimed in claim 32, wherein the at least one channel measurement data comprises at least one of path power, channel impulse response, path delays, path phase and path angles (AoD/AoA).

35. The method as claimed in claim 32, wherein the at least one positioning measurement data is at least one of path power, channel impulse response, path phase multipath delays, time difference of arrival (TDoA), relative time of arrival (RToA), angle of arrival (AoA), angle of departure (AoD), time of arrival (ToA), gNB/UE Tx-RX time difference of arrival, synchronization information, path phase, RSRP, measurement windows, path powers, and line-of-sight (LoS) condition.

36. The method as claimed in claim 32, wherein the at least one GTL data is at least one of time difference of arrival (TDoA), relative time of arrival (RToA), angle of arrival (AoA), angle of departure (AoD), time of arrival (ToA), gNB/UE Tx-RX time difference of arrival, line-of-sight (LoS) condition, and the at least one participating entity location.
